(19) United States
(12) Patent Application Publication
(10) Pub. No.: US 2008/0026913 A1
(43) Pub. Date: Jan. 31, 2008

(54) BRAKING SYSTEM FOR GOLF CAR

(76) Inventors: Takehiro Nakamoto, Shizuoka-ken (JP); Taikan Mizuno, Shizuoka-ken (JP)

Correspondence Address: ERNEST A. BEUTLER, ATTORNEY AT LAW, 10 RUE MARSEILLE, NEWPORT BEACH, CA, 92660, US

(21) Appl. No.: 11/460,475

(22) Filed: Jul. 27, 2006

(51) Int. Cl. B60W 10/04; B60W 10/00

(52) U.S. Cl. 477/184; 477/96

(57) ABSTRACT

A golf car operated by a prime mover under the control of an accelerator control a brake capable of being set in a locked condition for retaining the car from movement. Upon original operation of the prime mover the brake is not released until after a predetermined condition is established to insure against unwanted movement of the car before the prime mover is able to drive the car in the intended direction.

### BACKGROUND OF THE INVENTION

This invention relates to a golf car and more particularly to a brake releasing system and method for such cars.

A typical golf car, which has been traditionally used on golf courses, is disclosed in published Japanese Application, JP-A-2001-17589. Such a traditional golf car may be powered by a prime mover such as either an electric motor or an internal combustion engine. As is typical this golf car is provided with a parking brake for preventing car movement at desired times. Typically, in order to start such a golf car, an accelerator pedal is depressed, and accordingly, the parking brake that is mechanically connected to the accelerator pedal, is released. However, there is a time lag between depression of the accelerator pedal or release of the parking brake and the actual start of vehicle movement. For example, with an internal combustion engine driven vehicle, there is a time lag between the engine start-up and the achievement of a predetermined level of engine power in order to effect vehicle movement.

This may be best understood by reference to FIG. 1 which is a chart illustrating vehicle conditions when an engine driven golf car, provided with the conventional brake release mechanism, starts moving on a sloping road. The traces A to E indicate respectively ON/OFF state of an accelerator switch (A), engine speed (B), engine ignition output (C), ON/OFF state of the parking brake (D), and vehicle's behavior (E). Time is shown along the horizontal axis

As shown by (A), when a driver depresses the accelerator pedal at the time t₀, the accelerator switch is turned ON. Upon turning ON the accelerator switch at t₀, the parking brake is released as shown by (D). Thus, as shown by (E), the vehicle that has been stationary on the sloping road starts reversing in the down slope direction at t₀. After a small time lag after depressing the accelerator pedal, operation of the starter generator begins at t₁ to start engine cranking as shown by (B). After cranking, an ignition output begins at t₂ as shown by (C), and ignition starts at t₃, resulting in an increase in engine speed.

However it is not until t₄, that the engine torque reaches a level required for driving the vehicle forward on the sloping road, so that the vehicle starts running forward. Thus, under these conditions, the vehicle keeps reversing on the sloping road between t₀ and t₄. That is that when the accelerator pedal is depressed to start driving the golf car that has been stationary on the sloping road, the parking brake is released even though the golf car is not yet in a condition for running forward on the sloping road due to insufficient levels of engine speed and torque. This causes the golf car to reverse in the down slope direction.

In order to solve the aforementioned problem, one it has been proposed to use a mechanical structure for delaying the timing of release of the parking brake after the accelerator pedal is depressed. However, even using this mechanical structure, the parking brake may be released before sufficient engine power is obtained because of the extremely short time lag between depression of the accelerator pedal and release of the parking brake. In addition, the parking brake is released depending on the angle by which the accelerator pedal is depressed, or the like. Thus, the timing to release the parking brake differs depending on the quickness of driver's accelerating operation, and therefore drivers cannot always obtain consistent effects.

It is, therefore, a principal object of this invention to provide a brake releasing system and method for golf cars that upon desired vehicle start from a braked condition the brake is not released until the prime mover is generating sufficient power to drive the car in the desired direction.

### SUMMARY OF THE INVENTION

This invention is adapted to be embodied in a prime mover driven golf car having a brake for selected retention of the car in a stationary position. The prime mover is operated in response to an accelerator control.

In accordance with a car embodying the invention, the brake is released only when the prime mover is generating sufficient power to move the car in the desired direction.

In accordance with a method of operating the car, the brake is released only when the prime mover is generating sufficient power to move the car in the desired direction

### BRIEF DESCRIPTION OF THE DRAWINGS

FIG. 1 is a graphical time diagram showing a prior art type of automatic golf car brake release mechanism and method.

FIG. 2 is a partially schematic top plan view of a golf car constructed and operated in accordance with the invention.

FIG. 3 is a schematic view showing the controls for the golf car.

FIG. 4 is a graphical time diagram in part similar to FIG. 1 showing a first embodiment of the invention.

FIG. 5 is a graphical time diagram in part similar to FIGS. 1 and 4 and showing a second embodiment of the invention.

### DETAILED DESCRIPTION

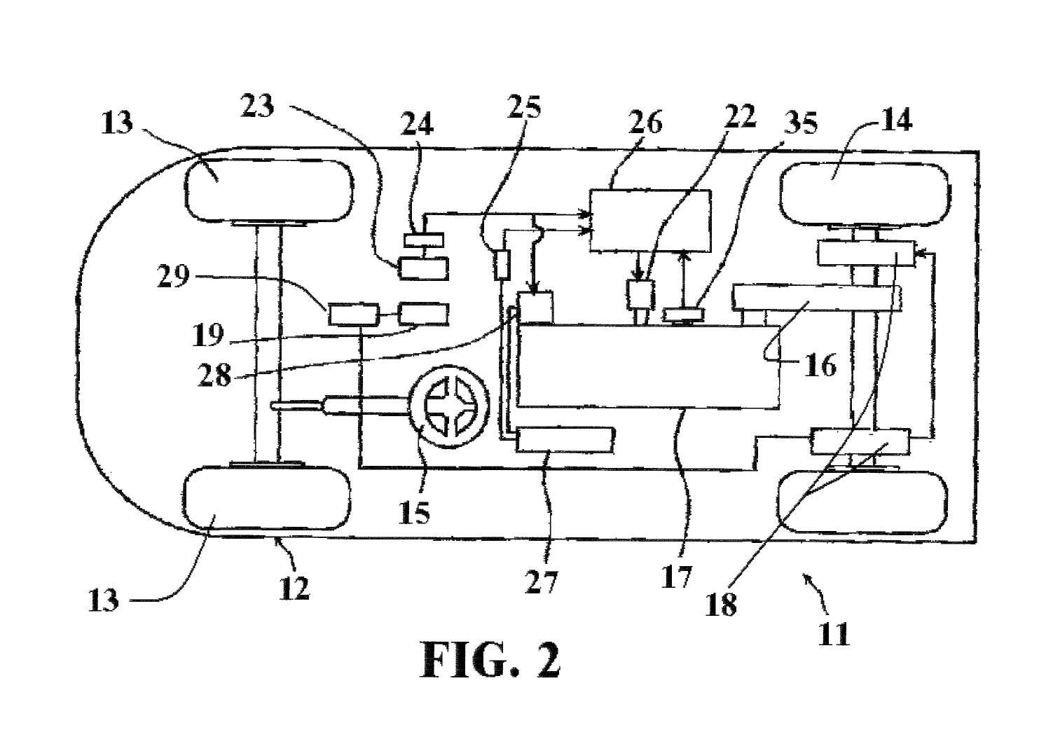

Referring again in detail to the drawings and initially to FIG. 2, A golf car embodying the invention is identified generally by the reference numeral 11 is comprised of a body portion 12 that may have any desired configuration and construction. This body portion 12 dirigibly supports, in a desired manner and through a suspension system, not shown, front wheels 13. In addition the body portion 12 further supports, again through any desired suspension structure, rear wheels 14.

The front wheels 13 are steered by an operator of the car 11 by a suitable steering mechanism by means of a steering wheel 15. The rear wheels 14 are driven through a transmission 16 from a prime mover such as a fuel injected internal combustion engine, indicated generally by the reference numeral 17. However those skilled in the art will readily understand that the prime mover may also comprise an electric motor.

At least the rear wheels 14 are provided with brakes 18 of a suitable type operated by means of a brake pedal 19 positioned in proximity to the operator. The brake pedal 19 has a parking brake function to lock up in a braking condition by depressing a parking brake pedal 19 to stop the vehicle. When stopped, the vehicle is made immovable by locking the parking brake. Its release will be described shortly.

The engine 17 includes an ignition system 21 of any desired type for firing spark plugs (not shown) in accordance with any desired control routine. The engine 17 is supplied with fuel via one or more fuel injectors (not shown). The engine operation is under the control of an accelerator pedal 23 that is disposed adjacent the brake pedal 19. An accelerator position detector 24 detects depressing operation of the accelerator pedal 23 by the operator. In the illustrated embodiment, when the operator depresses the accelerator pedal 23 the detector 24 outputs a signal so that the engine 17 and car 11 is driven at a constant speed. Of course those skilled in the art will readily understand how the invention can be practiced with systems wherein the prime mover and car speed may be variable,

The accelerator position detector 24 and a key operated main switch 25 are connected to an engine controller, indicated generally at 26. The controller 26 is supplied with power from a battery 27. For charging the battery 27 and providing electrical power for operation of the car 11 there is provided a starter generator 28.

As has been noted, the brake pedal 19 has a parking brake function to lock up in a braking condition by depressing a parking brake pedal to stop the vehicle. The brake pedal 19 is provided with a brake release mechanism 29. While the vehicle is stationary with parking brakes applied, the brake pedal 19 is depressed again to initiate release of the parking brakes. The brake release mechanism is operated in according with the invention, as will be described shortly.

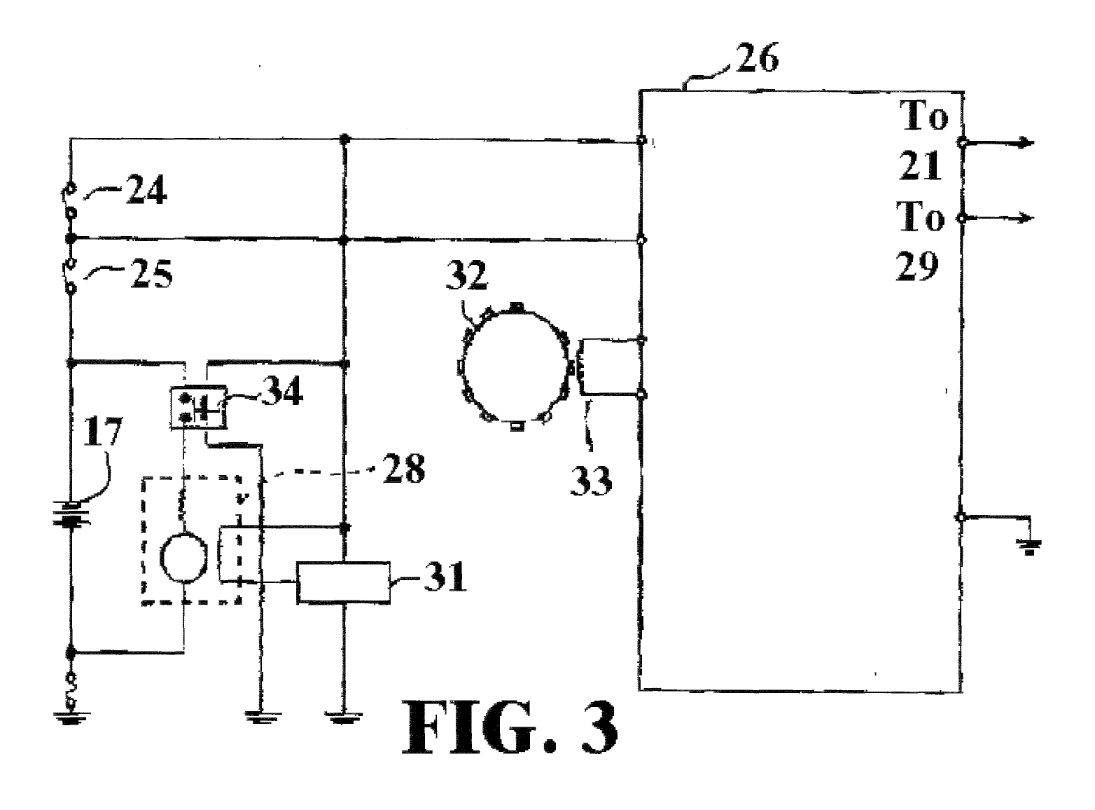

Referring now to FIG. 3, this is a circuit block diagram of the golf car 11. When the main switch 25 is turned ON, the battery 27 supplies power to the controller 26 and when the accelerator switch 24 is turned ON, an acceleration input signal is sent to the controller 26. When the main switch 25 and the accelerator switch 24 are both ON, the starter generator 28 starts-up via a relay or power on circuit 34. The starter generator 28 charges the battery 27 through a regulator 31 for electric power generation.

Rotation of the starter generator 28 cause the engine 17 to start. Attached for rotation to the engine crankshaft or any other shaft that rotates with the crankshaft is a rotor 32 having one or more timing marks that cooperates with a sensor 33 that sends pulser signals to the controller 26. The controller 26 calculates the rotational speed of the crankshaft and a crank angle based on these pulser signals. Upon determining the engine start-up, the controller 26 sends ignition signals to the engine ignition system 21. Further, determining a predetermined condition, for example in this embodiment that the engine speed reaches a certain preset value, the controller 26 sends a signal to initiate parking brake release by the break release mechanism 29.

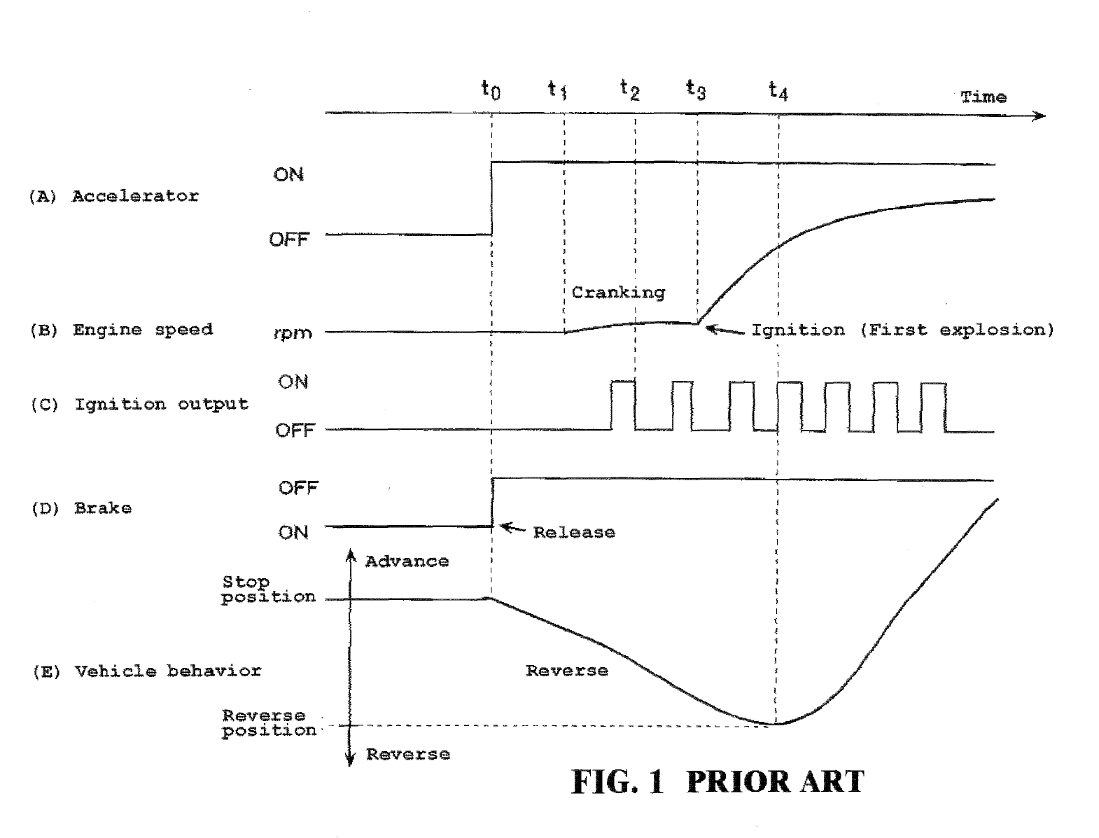

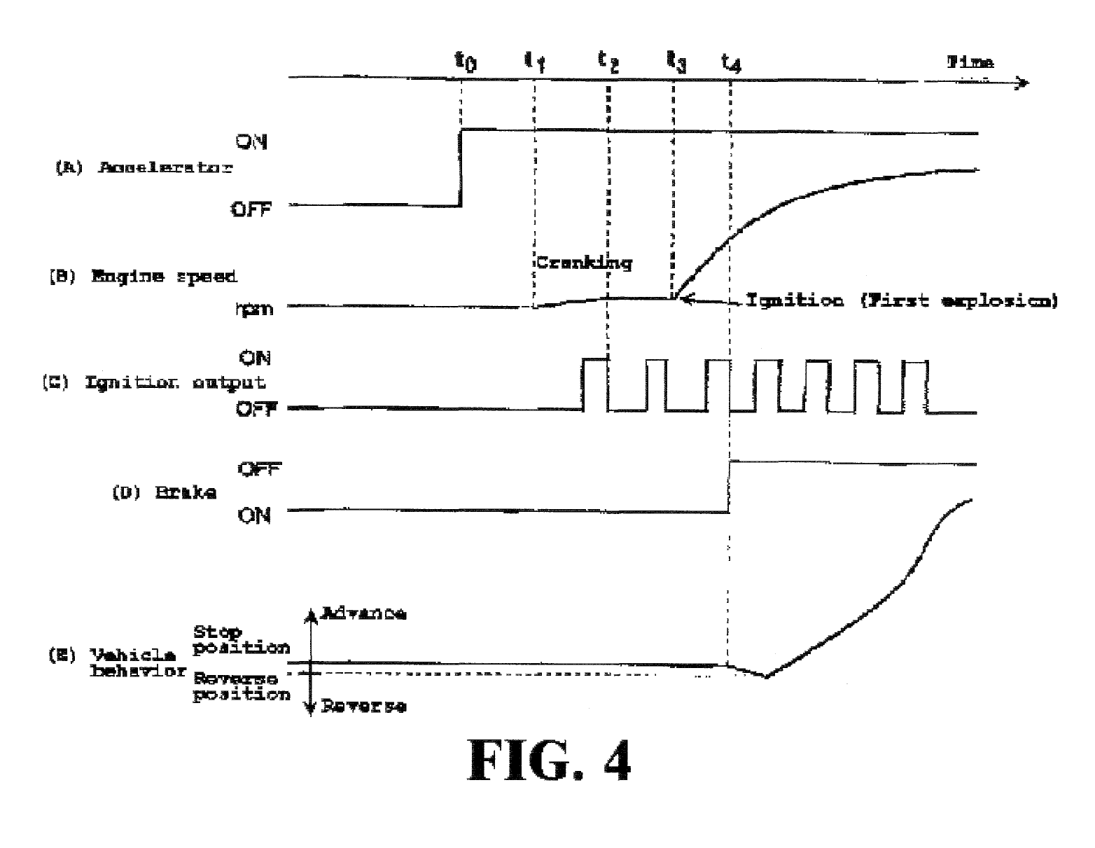

The operation of this embodiment will now be described by reference to FIG. 4 which should be compared with Prior Art FIG. 1 to show the improved result. The respective traces (A to E) are the of the same characteristics as those of FIG. 1. That is traces (A) to (E) indicate respectively ON/OFF state of the accelerator switch, engine speed, engine ignition output, ON/OFF state of the parking brake, and vehicle's behavior, respectively, while the horizontal axis represents lapse of time.

When operating in accordance with the circuit as shown in FIG. 3, and as shown by trace (A), the driver depresses the accelerator pedal 23 and then the accelerator switch 24 is ON at t₀. With a small time lag after the accelerator switch 24 is ON, the starter generator 28 starts-up at t₁ while the engine starts cranking. Then, ignition output begins at t₂, followed by ignition at t₃, so that the engine speed starts increasing, as shown by traces (B) and (C) respectively. However the brakes 18 are not released at the same time, as with the prior art. Then when the engine speed reaches a certain preset value at t₄, the parking brake is released as shown by the trace (D). This time delay in brake release insures that the engine is developing sufficient power to actually effect movement of the car 12. Thus, the vehicle starts moving at t₄, and soon moves forward in the upslope direction. However, the vehicle may reverse slightly by an extremely short distance in the down slope direction after t₄, depending on the slope angle and/or engine power, as shown by trace (E).

As described above, the engine speed required for releasing the parking brake is predetermined depending on, for example, the characteristics of the golf course. This prevents the parking brake from being released, if sufficient drive power has not yet been obtained after the accelerator pedal 23 was depressed. Thereby, the distance the vehicle move in reverse on the sloping road can thus be reduced or totally eliminated.

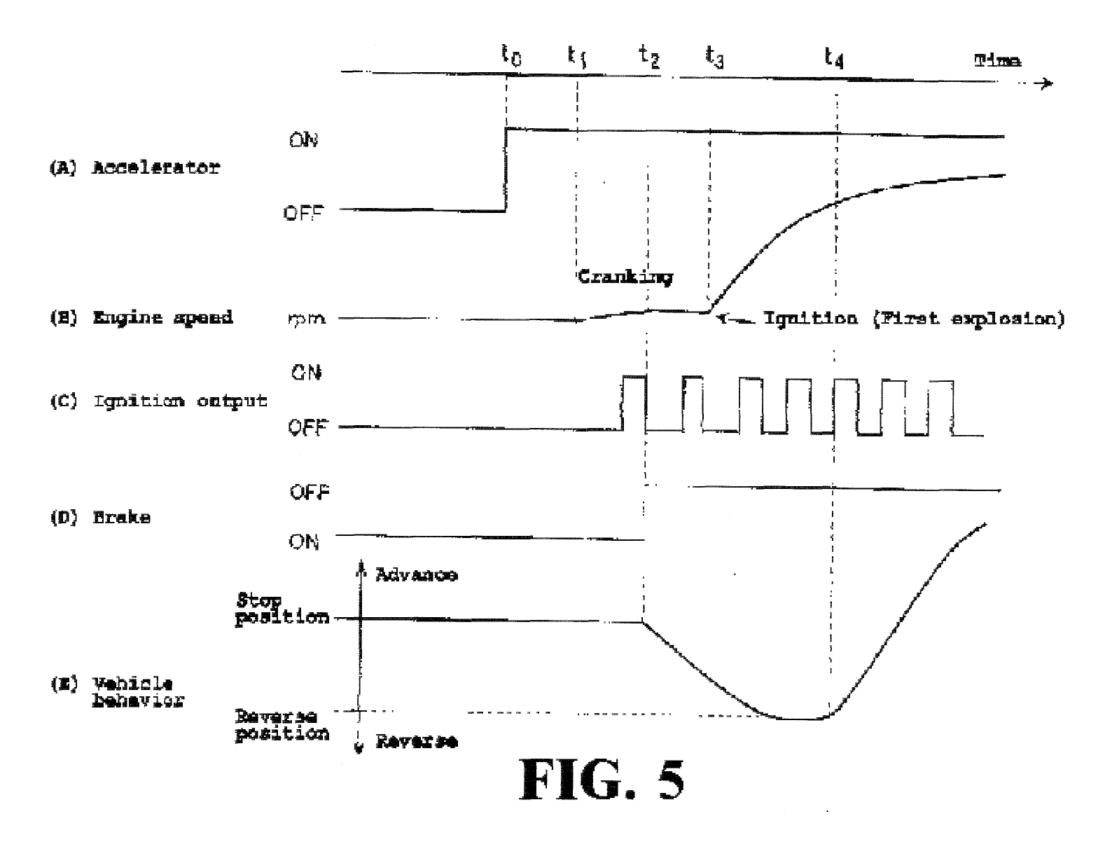

Referring now to FIG. 5, this shows another embodiment that delays brake release for a predetermined time after engine start up rather than actual engine speed. Like FIGS. 1 and 4 this figure is a chart illustrating different vehicle conditions when the golf car of the invention starts moving on the sloping road. (A) to (E) indicate the same characteristics as shown in FIGS. 1 and 4 and the horizontal axis again represents lapse of time.

As shown by trace (A), the driver depresses the accelerator pedal and then the accelerator switch is ON at t₀. With a small time lag after the accelerator switch is ON, the starter generator starts-up at t₁ while the engine starts cranking, and then, ignition output begins at t₂, as shown by traces (B) and (C), respectively. According to the second embodiment, at t₂ when an ignition signal is first generated, the parking brake is released as shown by trace (D).

Thus, the vehicle starts moving at t₂, and reverses slightly in the down slope direction, as shown by (E). However, after that, the engine ignition is started at t₃, and the engine speed thus starts increasing. Therefore, at t₄, the engine power reaches a level sufficient to enable the vehicle to move forward in the up slope direction.

In this embodiment, since the engine power at the time of releasing the parking brake is not sufficient to enable the vehicle to move forward in the upslope direction, the vehicle reverses slightly. However, the reverse distance is shorter compared to the conventional art (FIG. 1) using the parking brake that is released concurrently with depressing the accelerator pedal.

In addition, as in the first embodiment, increasing the engine power for releasing the parking brake may cause the vehicle on the flat road to start suddenly. Therefore, as noted in the second embodiment, releasing the parking brake with low engine power allows the vehicle on the flat road to start smoothly. Thus, the second embodiment may be more suitable for gently undulating courses, for example.

It should be obvious to those skilled in the art that the present invention may apply to any vehicles driven by a fuel injection engine or a carbureted engine having a controller, or in fact even an electric motor. Of course those skilled in the art will readily understand that the described embodiments are only of a exemplary forms that the invention may take and that various changes and modifications may be made without departing from the spirit and scope of the invention, as defined by the appended claims.

1. A golf car driven by a prime mover and having a brake for selected retention of said golf car in a stationary position an accelerator control for initiating the operation of said prime mover, and a brake release for releasing said brake at a predetermined condition after said accelerator control is actuated.

2. A golf car as set forth in claim 1 wherein the predetermined condition is the operation of the prime mover at a predetermined speed.

3. A golf car as set forth in claim 1 wherein the predetermined condition is a predetermined time after the initiation of the operation of the prime mover.

4. A golf car as set forth in claim 2 wherein the prime mover comprises an internal combustion engine.

5. A golf car as set forth in claim 3 wherein the prime mover comprises an internal combustion engine.

6. A brake releasing method for golf car driven by a prime mover and having a brake for selected retention of the golf car in a stationary position and an accelerator control for initiating the operation of the prime mover, said method comprising the steps of determining the accelerator control has been first actuated after the brake has been set and releasing the brake at a predetermined condition after the accelerator control is first actuated.

7. A golf car as set forth in claim 6 wherein the predetermined condition is the operation of the prime mover at a predetermined speed.

8. A golf car as set forth in claim 6 wherein the predetermined condition is a predetermined time after the initiation of the operation of the prime mover.

9. A golf car as set forth in claim 7 wherein the prime mover comprises an internal combustion engine.

10. A golf car as set forth in claim 8 wherein the prime mover comprises an internal combustion engine.
